(19) United States
(12) Patent Application Publication
(10) Pub. No.: US 2001/0022246 A1
(43) Pub. Date: Sep. 20, 2001

(54) VEHICLE POWER SOURCE

(75) Inventors: BRIAN C. DUNBRIDGE, TORRANCE, CA (US); BARRY DUNBRIDGE, TORRANCE, CA (US)

Correspondence Address: IRVING KESCHNER, 21515 HAWTHORNE BOULEVARD, SUITE 1150, TORRANCE, CA, 90503

(73) Assignee: Brian c. Dimbridge

(21) Appl. No.: 09/393,070

(22) Filed: Sep. 7, 1999

(51) Int. Cl. B60K 1/00

(52) U.S. Cl. 180/65.8; 180/220

(57) ABSTRACT

A unique drive transfer device for use with personal electric vehicles, such as bicycles and scooters. In particular, a cordless, battery-driven rotary hand held tool is mounted to the vehicle in a manner whereby the rotatable output shaft of the tool is coupled to the rear wheel of the vehicle to drive the vehicle. The tool is powered by one or more batteries, a battery pack being mounted to the vehicle. The tool output shaft provides torque on demand and is sufficient to drive the vehicle over a wide range of speeds.

### BACKGROUND OF THE INVENTION

1. Field of the Invention

The present invention provides a novel power train source for various forms of transportation vehicles and, in particular, wherein a cordless, rechargeable battery-driven hand held power tool is adapted to power the vehicle with high performance and low cost benefits.

2. Description of the Prior Art

Various types of electric driven vehicles have been disclosed in the prior art. The most visible of these devices is the battery powered automobile which is currently being tested and could be offered for commercial sale in the near future.

Various types of scooters and bicycles have also been powered by electric batteries. For example, U.S. Pat. No. 5,775,452 to Patmont discloses an electric powered scooter wherein the rear wheel is electrically powered; U.S. Pat. No. 5,613,569 to Sugioka et al discloses an electric motor vehicle with a smaller sized battery and means for cooling the battery; U.S. Pat. No. 5,842,535 to Dennis discloses a bicycle having a battery power pack, an electric motor, and a drive wheel; U.S. Pat. No. 5,594,411 to Ono discloses an electromotive scooter having a power source and a warning device which warns the rider and passerby when the scooter is ready to run; U.S. Pat. No. 5,396,970 to Cho discloses a power source which supplies high voltage to the electric motor driving a scooter to provide high driving performance; U.S. Pat. No. 5,388,659 to Pepe which discloses a foldable motorized scooter having a unique drive transfer device; U.S. Pat. No. 5,207,288 to Ono discloses a lightweight electromotive scooter wherein the batteries are positioned to provide a low scooter center of gravity; and U.S. Pat. No. 5,020,624 to Nesterick et al which discloses a power drive scooter having an on-board battery powered motor for driving one or more wheels, the scooter being designed to be easily assembled and disassembled.

All of the devices described hereinabove require an electric drive motor to power the vehicle. The drive motor, depending on size, is relatively expensive and requires a specific drive mechanism to link the motor output shaft to the vehicle drive wheel. The cost of servicing the drive motor and associated mechanism, when added to the initial costs of the vehicle, makes the cost of ownership relatively expensive. Further, the typical power output of the batteries which drive the vehicle is usually low, making electric driven vehicles less competitive with internal combustion driven vehicles as far as torque/power capabilities are concerned.

What is thus desired is to provide a power source for use with electric vehicles which is less expensive and more reliable than those currently available.

### SUMMARY OF THE PRESENT INVENTION

The present invention provides a unique drive transfer device for use with personal electrical vehicles, such as bicycles and scooters. In particular, a cordless, battery-driven rotary hand held tool is mounted to the vehicle in a manner whereby the rotatable output shaft of the tool is coupled to the rear wheel of the vehicle to drive the vehicle. The tool is powered by one or more batteries mounted to the tool or vehicle, and is adapted to be removable. The tool output shaft provides torque on demand and is sufficient to drive the vehicle over a range of speeds. The device can also be used to power other items, such as cross-country skis (auxiliary powered wheels to aid skier in uphill climbs, with the wheel being on either or both sides of the ski and driven by the electric power train of the present invention) and mountain climbing apparatus (used for an electric driven pulley).

The present invention thus provides a relatively inexpensive, widely available power drive transfer device which replaces the more costly, service prone electric motors currently in use with most personal electrical vehicles and also provides a device that is easily adaptable to other uses.

### BRIEF DESCRIPTION OF THE DRAWING

For better understanding of the present invention as well as other objects and further features thereof, reference is made to the following description which is to be read in conjunction with the accompanying drawing therein:

FIG. 1 is an elevation view of a motorized scooter using the drive transfer device of the present invention;

FIG. 2 is a plan view of the motorized scooter shown in FIG. 1;

FIG. 3 is a view along line 3-3 of FIG. 2;

FIG. 4 is a view along line 4-4 of FIG. 3;

FIG. 5 is a view along line 5-5 of FIG. 3;

FIG. 6 is a view along line 6-6 of FIG. 3; and

FIG. 7 is a view along line 7-7 of FIG. 6.

### DESCRIPTION OF THE INVENTION

Referring now to FIG. 1, a side, or elevational view of a scooter 10 incorporating the novel drive transfer mechanism 12 of the present invention is illustrated. Although the mechanism 12 is shown adapted for use with scooter 10, it should be noted that mechanism 12 can be used with other personal electrical vehicles, such as bicycles, cross-country skis, rescue equipment and mountain climbing apparatus.

Scooter 10 is of conventional design and includes steering handle 14, front wheel 16, frame 18 including portion 20 wherein the user can stand or sit, and rear driving wheel 22.

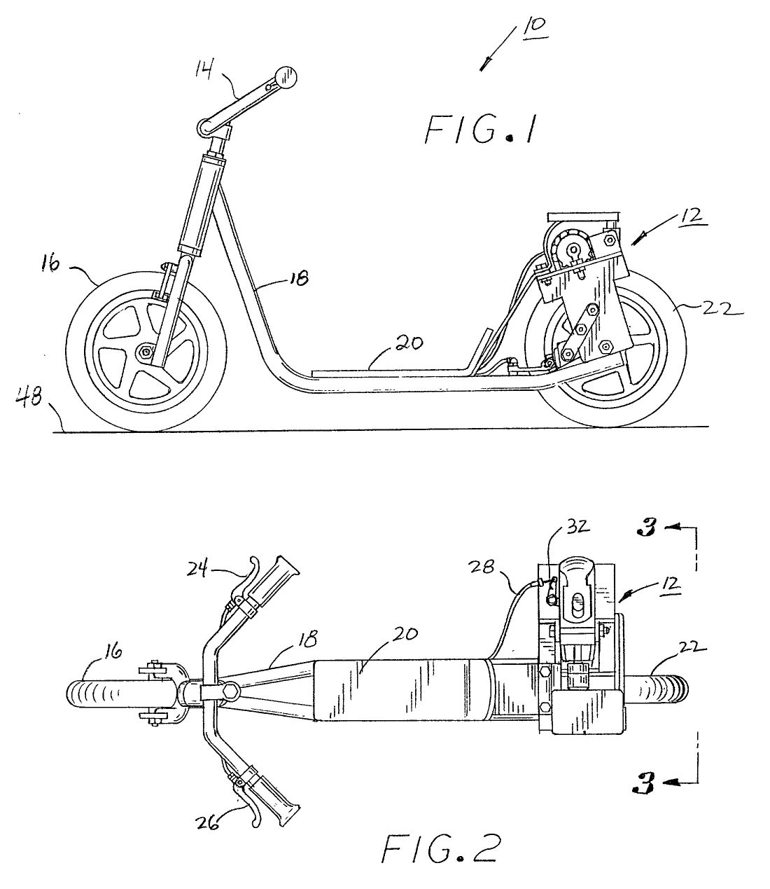

FIG. 2 illustrates hand brakes 24 and 26 and split frame 18. Also shown is control line 28 connected between hand control lever 30 and lever 32. As will be explained hereinafter in more detail, adjusting lever 30 controls the rotational speed of the output drive mechanism shaft, thus controlling the output torque, (and thus speed) of the output shaft. In particular, a handle bar mounted brake lever is used to actuate the drill speed control button (not illustrated).

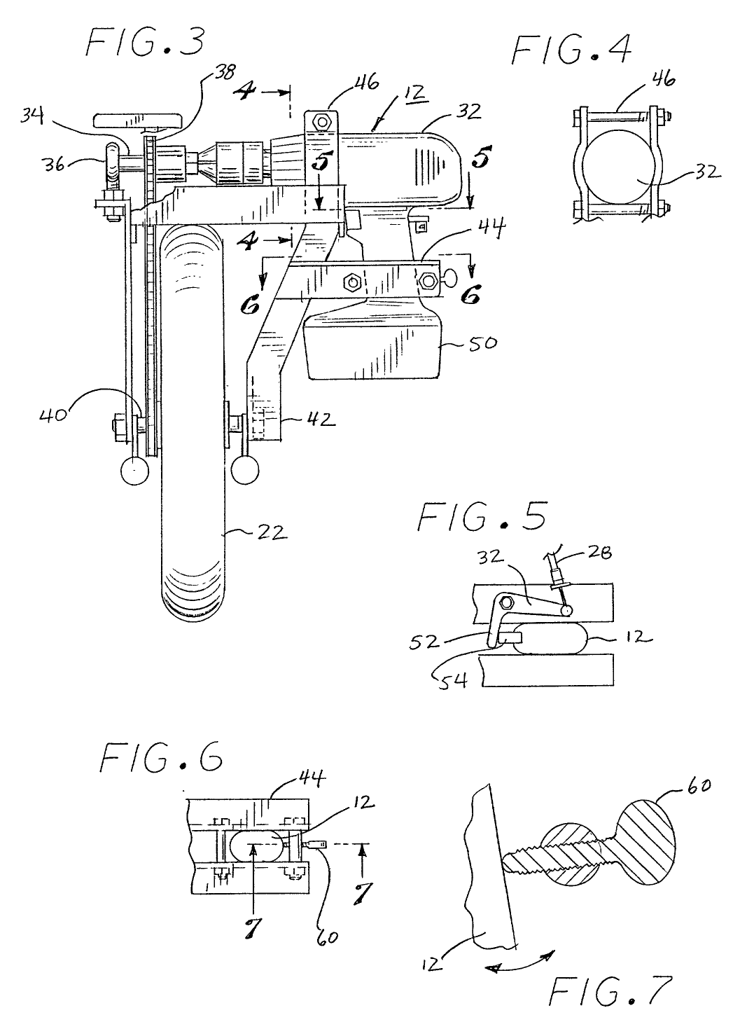

FIG. 3 shows the novel transfer drive mechanism of the present invention in more detail. In accordance with the teachings of the present invention, the prime drive mechanism comprises a cordless, portable, battery-driven hand held tool 32. Tool 32, in the embodiment illustrated, comprises a conventional power drill with a plug-in battery pack (an example of such tool is the Dewalt® DW995K-2 driver/drill manufactured by the Black & Decker Corporation, Towson, Md.) although other types of hand held tools can be utilized. The important feature of the present invention is that any high torque, rotary motion tool having a dc electric motor can be utilized. The tool output shaft 34, the end of which is supported by bearing 36, is coupled to sprocket 38 which in turn is coupled to axle 40 of wheel 22. Bracket members 42, 44 and 46 are arranged to support tool 32 in a manner such that sprocket 38 is engaged and at a height above ground 48 such that the drive mechanism does not contact the ground when the scooter is tilted during turning maneuvers. A battery pack 50 is shown connected to tool 32 in a conventional manner. A typical battery pack 50 provides up to one hour of scooter operation.

The torque provided by the tool 32 is provided on demand and is sufficient to drive the rear wheel 22 such that scooter can move at predetermined speeds. For a conventional power drill tool, a prototype of scooter 10 was able to obtain speeds of up to 25 miles per hour although theoretically being capable of going as fast as 60 miles per hour.

FIG. 4 illustrates the configuration of bracket member 46 for supporting tool 32.

FIG. 5 illustrates the on-off control of driver mechanism 12 in the embodiment illustrated. In particular, cable 28 is coupled to lever 32, leg 52 of lever 32 being positioned adjacent on-off switch 54 (it should be noted that switch 54 can also be configured to control the speed of shaft 34).

FIG. 6 shows bracket support member 44 in more detail and how it functions to fixedly support tool 32.

FIG. 7 shows a mechanism for enabling tool 12 to be tilted by adjusting screw member 60.

The present invention thus provides a mechanism for enabling an electrical vehicle to be powered without utilizing a custom, expensive electric motor, the mechanism being a conventional, low cost, low maintenance, portable, rotatable, power tool already commercially available.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. An electrically powered vehicle for powered movement over a ground surface comprising:
a vehicle frame member having a rear wheel mount at one end and a front wheel mount at the other end with a frame support member extending therebetween;
a front wheel mounted to the front wheel mount for turning steering movement with respect to the front wheel mount;
a frame member supported rear wheel;
a power tool having an output shaft; and
means for coupling said output shaft to said rear wheel whereby said rear wheel is driven in a manner such that said vehicle is moved relative to said ground surface.

2. The vehicle of claim 1 wherein said power tool output shaft rotates relative to the longitudinal axis of said power tool.

3. The vehicle of claim 1 further including a removable battery means coupled to said power tool to provide the required power thereto.

4. The vehicle of claim 1 further including a front handle bar mounted to said frame member.

5. The vehicle of claim 4 further including a speed control member associated with said front handle bar, said member being coupled to said power tool whereby the shaft output speed is controllable.
